(19) United States
(12) Patent Application Publication
(10) Pub. No.: US 2025/0259061 A1
(43) Pub. Date: Aug. 14, 2025

(54) LAYER-WISE FILTER THRESHOLDING BASED CNN PRUNING FOR EFFICIENT IOT EDGE IMPLEMENTATIONS

(71) Applicant: UNIVERSITY OF SOUTH FLORIDA, Tampa, FL (US)

(72) Inventors: Srinivas KATKOORI, Tampa, FL (US); Lakshim Kavya KALYANAM, Tampa, FL (US)

(21) Appl. No.: 19/050,109

(22) Filed: Feb. 10, 2025

Related U.S. Application Data
(60) Provisional application No. 63/552,084, filed on Feb. 9, 2024.

(51) Int. Cl. G06N 3/082; G06N 3/0464

(52) U.S. Cl. CPC G06N 3/082; G06N 3/0464

(57) ABSTRACT

Methods and systems for optimized pruning and structuring of trained convolutional neural networks are provided. In some methods, the weight matrices of one or more convolutional layers of a trained CNN model are profiled and a weight distribution is determined. Based on this, a pruning threshold may be determined, and utilized to prune weights of the matrices whose values are below the threshold. This may be iteratively repeated until an optimal tradeoff of model reduction vs accuracy is achieved. Resulting pruned models may be utilized in resource constrained applications, such as in edge or IoT devices, or may be utilized to develop optimized, custom circuits or chips with reduced transistor count that perform the classification task of the trained CNN model.

### CROSS-REFERENCE TO RELATED APPLICATION(S)

This application claims priority to U.S. Provisional Patent Application Ser. Nos. 63/552,084 filed Feb. 9, 2024, the content of which is hereby incorporated by reference in its entirety.

### STATEMENT REGARDING FEDERALLY SPONSORED RESEARCH

N/A

### BACKGROUND

Convolutional Neural Networks (CNNs) are designed to process and analyze visual data by applying a series of convolutional operations across multiple layers. These networks are used to extract hierarchical features from input images, enabling tasks such as image classification and object detection. However, the computational complexity of CNNs, driven by the large number of parameters and operations, poses significant challenges for deployment on devices with limited resources.

CNNs require substantial computational power due to the extensive matrix operations involved in both training and inference phases. As the network's depth and complexity increase, so does the number of parameters, which results in higher processing demands. Additionally, CNNs require significant memory to store weights, intermediate results, and feature maps, which adds further strain to devices with limited memory capacity.

The memory usage of CNNs is compounded by the need to frequently transfer data between the processor and memory, leading to inefficiencies in terms of both time and energy consumption. These challenges make it difficult to implement CNNs on resource-constrained devices such as mobile phones, embedded systems, and IoT edge devices, which have limited processing power and memory bandwidth. In particular, these methods may not effectively capture the weight distribution within each layer, potentially leading to inefficient pruning and the removal of important network information. This inefficiency is especially problematic for resource-constrained devices, such as mobile phones, embedded systems, and IoT edge devices, where computational power and memory are limited. The inability of traditional pruning methods to dynamically adjust based on the weight distribution further exacerbates these challenges, making CNNs difficult to deploy efficiently on such devices.

Optimizing CNNs for hardware involves reducing both their computational complexity and memory footprint. Techniques such as model compression, pruning, and quantization are used to decrease the number of parameters, thus reducing memory usage and processing time. These optimizations enable CNNs to operate more efficiently on resource-constrained devices without significantly impacting performance.

Hardware optimization of CNNs is crucial for enabling their practical use in real-time applications on mobile, IoT, and embedded systems. By addressing the computational and memory constraints of these devices, optimizations make it possible to deploy CNNs for image analysis and other tasks without compromising accuracy or efficiency.

There exists a need to address the drawbacks of traditional pruning methods for CNNs, which typically rely on fixed threshold values for weight removal. One way to accomplish the right balance between these goals, is through the design and implementation of efficient chip architectures that allow for performance of specific operations that would otherwise require high power/cost general processors.

The present disclosure introduces a novel chip architecture construct and design methodology that address the unique challenges faced by IoT, mobile, and edge devices in a category of processing that previously had been challenging to implement in such devices. In particular, the present disclosure introduces a novel technique called range-based threshold pruning for optimizing CNNs that is implement via the chip. This method leverages the weight ranges within each layer to dynamically determine the pruning threshold, providing finer control over the pruning process. By profiling the weight matrix of a pre-trained CNN and calculating the maximum weight value for each layer, the threshold can be normalized accordingly. This approach allows for selective pruning of weights below the threshold, while preserving important network information. The proposed method leads to improved network efficiency, reduced memory footprint, and enhanced suitability for deployment on resource-constrained devices.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a method for optimizing a pre-trained convolutional neural network (CNN) model, the method comprising: obtaining a trained CNN model, the trained CNN model comprising a plurality of convolutional layers and associated weight matrices; profiling the weight matrix of one or more of the plurality of convolutional layers to determine a weight distribution for the one or more layers; determining a pruning threshold for each of the one or more convolutional layers based on the weight distribution; iteratively pruning weights in the weight matrix of the one or more convolutional layers by setting weights below the pruning threshold to zero, to generate an initial pruned CNN model; evaluating an accuracy of the initial pruned CNN model on a test dataset; adjusting the pruning threshold dynamically for the one or more convolutional layers, based on the evaluated accuracy; and generating an optimized CNN model comprising the one or more pruned convolutional layers.

In other aspects, the present disclosure can provide a system for CNN optimization, the system comprising: a communication connection configured to receive a trained CNN model; an electronic processor; and a non-transitory computer-readable medium storing machine-executable instructions that, when executed by the electronic processor, cause the system to: obtain a trained CNN model comprising a plurality of convolutional layers; profile a weight matrix of a first convolutional layer to determine a weight distribution for the first convolutional layer; determine a pruning threshold for the first convolutional layer based on the weight distribution; iteratively prune weights from the weight matrix of the first convolutional layer by setting weights having values that are below the pruning threshold to zero; evaluate an accuracy of the CNN model after pruning of the first convolutional layer, using a test dataset; adjust the pruning threshold dynamically based on the evaluated accuracy; and generate an optimized CNN model comprising the pruned first convolutional layer.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a system for generating or utilizing a pruned CNN according to some embodiments.

FIG. 2 is a flowchart diagram for a range-based threshold pruning for optimizing convolutional neural networks, according to some embodiments.

### DETAILED DESCRIPTION

Throughout the disclosure, the terms “near,” “about,” and “approximately” refer to a range of values ±5% of the numeric value that the term precedes.

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

Various embodiments, features, and examples of the present disclosure can also be found in the attached appendices, comprising academic articles which describe the inventors' work. These articles support the breadth of and are not limiting of the scope of the present disclosure.

### Example Range-Based Hardware Optimization System

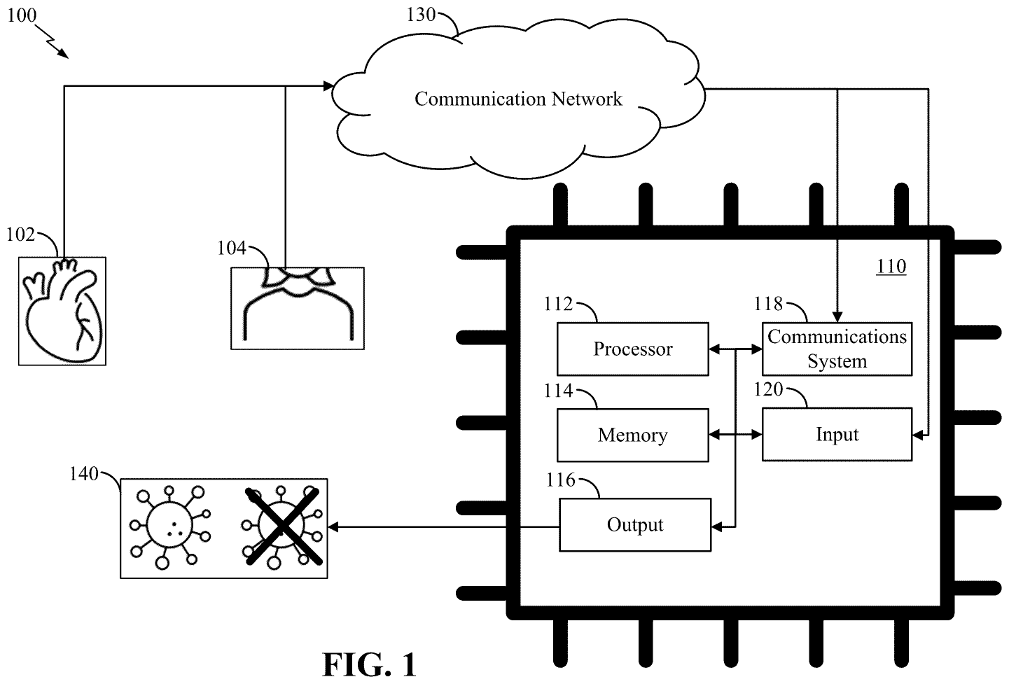

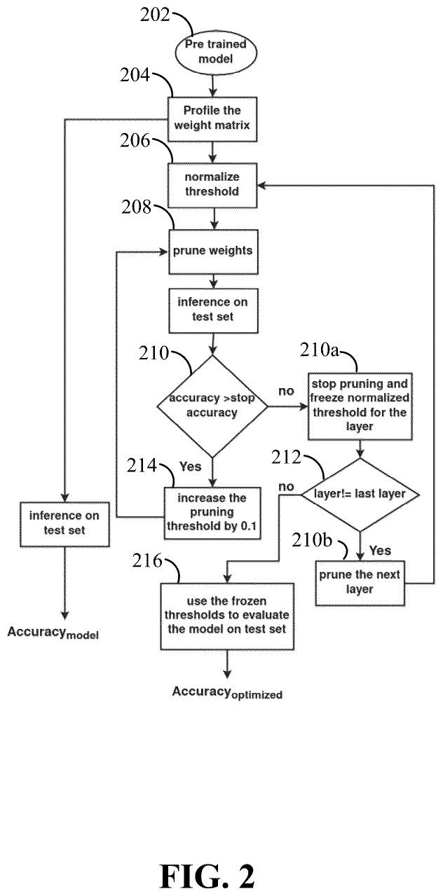

FIG. 1 shows a block diagram illustrating a system 100 for range-based hardware optimization for a convolutional neural network (CNN) model according to some embodiments. The computing device 110 can be an integrated circuit (IC), a computing chip, or any suitable computing device. In some examples, the computing device 110 can be a special-purpose device to implement a CNN model optimized through layer-wise pruning. Thus, the process 200 described in FIG. 2 is tied to a special-purpose device.

In the system 100, a computing device 110 can obtain or receive a dataset. The dataset can be a heart disease dataset 102, a breast cancer dataset 104, an Iris flower dataset, or any other suitable dataset for training and inference of a CNN model. For example, the dataset can include an image, a medical record, X-ray data, magnetic resonance imaging (MRI) data, computed tomography (CT) data, or any other suitable data for CNN-based classification or object detection. In some examples, the dataset for which a CNN model can provide classification may include multi-dimensional image data/features. In some examples, the dataset can be directly applied to the CNN model. In other examples, one or more features can be extracted from the dataset and be applied to the CNN model. The computing device 110 can receive the dataset, which may arise from a sensor or was stored in a database, via communication network 130 and a communications system 118 or an input 120 of the computing device 110.

The computing device 110 can include an electronic processor 112, a set of inputs (i.e., input pins 120), a set of output pins, and a layout of circuit gates (or specialized accelerator hardware for CNN inference), which cause the electronic processor 112 to perform instructions, which are stored in a memory 114.

The computing device 110 can include a processor 112. In some embodiments, the processor 112 can be any suitable hardware processor or combination of processors, such as a central processing unit (CPU), a graphics processing unit (GPU), an application-specific integrated circuit (ASIC), a field-programmable gate array (FPGA), a digital signal processor (DSP), a microcontroller (MCU), etc. In some embodiments, the processor 112 is configured to execute CNN inference tasks by performing optimized convolutional operations using the pruned network model.

The computing device 110 can further include a memory 114. The memory 114 can include any suitable storage device or devices that can be used to store suitable data (e.g., the dataset, a trained CNN model, an optimized CNN model, etc.) and instructions that can be used, for example, by the processor 112 to: when receiving a runtime dataset (such as an image input) via the set of input pins, extract a plurality of feature maps from the runtime dataset; apply the plurality of feature maps to the optimized CNN model to obtain a confidence level; and output a classification (e.g., an object detection result) based on the confidence level via the output pins. In other examples, the instructions may cause the computing device 110 to prune and optimize a pre-trained CNN, such as causing it to: obtain a trained CNN model, the trained CNN model comprising a plurality of convolutional layers and filters; determine a plurality of weight distributions for the convolutional layers based on a plurality of training datasets, the weight distributions corresponding to the convolutional layers; remove a first filter or weight connection from the trained CNN model based on a range-based threshold value to decrease hardware computational resources utilized for the filter or connection; generate an optimized circuit layout for hardware that implements an optimized CNN model generated based on the plurality of pruned convolutional layers; manufacture a chip according to the optimized circuit layout, wherein the chip has a first number of gates less than a second number of gates for a second chip implementing the trained CNN model; and remove the zeroed-out filters or channels from the CNN.

The memory 114 can include a non-transitory computer-readable medium including any suitable volatile memory, non-volatile memory, storage, or any suitable combination thereof. For example, memory 114 can include random access memory (RAM), read-only memory (ROM), electronically-erasable programmable read-only memory (EEPROM), one or more flash drives, one or more hard disks, one or more solid-state drives, one or more optical drives, etc. In some embodiments, the processor 112 can execute at least a portion of process 200 described below in connection with FIG. 2.

The computing device 110 can further include a communications connection 118. The communications system 118 can include any suitable hardware, firmware, and/or software for communicating information over the communication network 140 and/or any other suitable communication networks. For example, the communications system 118 can include one or more transceivers, one or more communication chips and/or chipsets, etc. In a more particular example, the communications system 118 can include hardware, firmware and/or software that can be used to establish a Wi-Fi connection, a Bluetooth connection, a cellular connection, an Ethernet connection, etc.

The computing device 110 can receive or transmit information (e.g., dataset 102, 104, a CNN inference result 140, a trained CNN model, etc.) and/or any other suitable system over a communication network 130. In some examples, the communication network 130 can be any suitable communication network or combination of communication networks.

In some examples, the computing device 110 can further include an output 116. The output 116 can include a set of output pins to output a CNN inference result, such as an image classification label, object detection coordinates, or feature extraction values. In other examples, the output 116 can include a display to output a visualized CNN-generated feature map or classification result. In some embodiments, the display 116 can include any suitable display devices, such as a computer monitor, a touchscreen, a television, an infotainment screen, etc., to display the classification results or object detection bounding boxes.

In further examples, the CNN model implemented on the computing device 110 may be designed for edge computing applications, requiring optimizations for real-time inference with limited computational resources.

### Example Optimization Process for CNN

CNNs (Convolutional Neural Networks) are a type of neural network widely used in image and video recognition tasks. CNNs consist of several layers, each performing a specific operation on the input data. The first layer is a convolutional layer that applies filters to the input image, producing a set of feature maps. Following the convolutional layer, there are pooling layers that down sample the feature maps, and fully connected layers that perform classification or regression based on the extracted features. CNNs are typically trained using backpropagation, a method that adjusts the network's weights to minimize the error between predicted and actual outputs. The training process often involves large, labeled image datasets.

CNNs are applied across a range of domains, including natural language processing, speech recognition, recommendation systems, and biomedical image analysis, in addition to their primary use in computer vision. In areas such as sentiment analysis, language translation, speech recognition, and biomedical image classification, CNNs have shown promising results. The ability of CNNs to automatically learn hierarchical representations from input data allows them to be applied to fields beyond computer vision, such as natural language processing and drug discovery. Pruning CNNs has emerged as a significant hardware optimization technique.

Other methods available to enhance the hardware performance of CNNs. For example, quantization is a technique that reduces the precision of the network's weights and activations. For example, using 8-bit integers instead of 32-bit floating-point numbers can considerably reduce memory requirements and improve the speed of the network. Pruning, as a method for optimizing CNNs, involves removing redundant weights from the network, which reduces its size and computational demands. This technique is crucial for hardware implementations of CNNs and has been proven effective in reducing hardware requirements while maintaining accuracy and performance. Weight sharing is another technique that reduces memory requirements by allowing multiple neurons to share the same weights. By decreasing the number of unique weights stored in memory, this method lowers memory bandwidth demands, improving the efficiency of CNNs, particularly on resource-constrained devices. Hardware-specific optimizations focus on tailoring the architecture and algorithms of the network to the hardware platform on which it will be deployed. Custom-designed hardware for convolutional operations can significantly enhance the speed and efficiency of the network.

Efficient memory management is also vital when optimizing CNNs for hardware. Techniques such as data augmentation and batch normalization can reduce memory usage during training, while model compression can be applied during inference to further lower memory requirements. These optimization methods collectively improve the efficiency and performance of CNNs when deployed on hardware devices with limited resources, such as embedded systems or mobile devices.

Neuron pruning is a technique in deep learning designed to improve the efficiency of a neural network by reducing the number of neurons. This optimization enhances the network's resource usage, enabling it to operate more efficiently on hardware with limited processing resources, such as IoT devices and edge computing platforms. By removing unnecessary neurons, the computational cost is reduced, leading to better performance on devices with constrained capabilities.

Several methods are used for pruning neurons, including weight pruning, connection pruning, and neuron pruning. Weight pruning eliminates neurons associated with low-weight connections, assuming these connections contribute less to the network's performance. Connection pruning removes entire neuronal connections, while neuron pruning eliminates whole neurons from the network. These techniques reduce computational expenses and optimize the model's resource usage, which is crucial for hardware-limited environments.

Neuron pruning provides several benefits, such as improved resource utilization and reduced computational cost. Pruning neurons with minimal impact on the model's accuracy can also lead to improved performance. By focusing the remaining neurons on the essential features of the input data, pruning reduces overfitting and noise, which in turn improves the model's overall accuracy. This results in an optimized model capable of operating more efficiently on hardware with limited resources.

Two primary approaches are used for pruning CNNs, which are structured pruning and unstructured pruning. Structured pruning involves removing entire neurons or groups of neurons from the network. This method is referred to as “structured” because the pruned weights are part of a larger, organized structure, such as filters or channels within convolutional layers. By eliminating entire structures, structured pruning reduces the network's size and computational requirements, making it more efficient for deployment on resource-constrained devices.

Unstructured pruning removes individual weights from the network, regardless of their placement within a larger structure. This method offers greater potential for compression, as it targets redundant weights that do not significantly affect the network's performance. Unstructured pruning is particularly useful in networks with high redundancy, where a large number of weights can be removed without compromising the model's functionality.

Structured pruning can be further divided into specific techniques, such as channel pruning, filter pruning, and layer pruning. Channel pruning removes entire channels from a convolutional layer based on their importance scores. This technique is efficient because it can eliminate a large number of parameters with minimal or no loss of precision. Filter pruning removes whole filters, which are clusters of weights corresponding to specific output feature maps. Filter pruning can be more precise than channel pruning but requires more granular importance scoring. Layer pruning removes entire layers from the network, reducing the computational cost. However, this approach carries risks, as removing crucial layers may degrade network performance.

The choice between structured and unstructured pruning depends on the specific application and hardware constraints. Unstructured pruning is typically used when the network contains a large number of redundant weights that can be safely removed. Structured pruning is more suitable when entire structures, such as filters or channels, can be pruned without affecting the network's overall function. Both approaches can reduce the size and computational cost of CNNs, making them more efficient for deployment on resource-constrained devices.

LeNet-5 is a CNN architecture that has been extensively used as a benchmark for various image-processing tasks. It consists of seven layers. The first layer is the input layer, which receives the input image, typically a 32×32 grayscale image. The second layer is a convolutional layer that applies six 5×5 filters to the input image, producing six feature maps. These filters have a stride of 1 and are padded with zeros to preserve the spatial dimensions of the input. The third layer is a pooling layer that performs subsampling on each of the six feature maps produced by the previous layer. It uses 2×2 filters with a stride of 2, reducing the spatial dimensions of each feature map by a factor of 2. The fourth layer is the second convolutional layer, which applies 16 5×5 filters to the feature maps produced by the previous layer, producing 16 new feature maps. The fifth layer is a second pooling layer that performs subsampling on each of the 16 feature maps produced by the previous layer, using the same 2×2 filters with a stride of 2. The sixth layer is a fully connected layer that flattens the output of the previous layer into a 120-dimensional vector and applies a fully connected neural network with 120 hidden units. The seventh and final layer is another fully connected layer that flattens the output of the previous layer into an 84-dimensional vector and applies a fully connected neural network with 84 hidden units.

LeNet-5 has been widely studied and experimented with over the years, with many researchers exploring new and innovative ways to optimize its performance for various tasks and hardware platforms. Different activation functions have been explored, such as ReLU and sigmoid, to improve the network's performance. The ReLU activation function is used in the LeNet-5 network in the present example.

LeNet-5 is used in numerous applications, including handwritten digit recognition, object detection, and facial recognition. A notable application of LeNet-5 is the recognition of handwritten characters, such as postal codes on letters and checks. The architecture of LeNet-5 has influenced many other CNNs, including AlexNet, VGGNet, and ResNet. LeNet-5 is also implemented in Internet of Things (IoT) applications requiring efficient and accurate image recognition. One such application is smart surveillance systems, where LeNet-5 enables the detection and identification of specific objects, such as people, vehicles, and animals, while also facilitating automatic alerting and notifications. LeNet-5 can also be utilized in IoT-based healthcare applications, including remote patient monitoring. With the increasing number of ubiquitous devices, patients can now collect and transmit large amounts of physiological data, including images. LeNet-5 can accurately classify and analyze medical images, such as X-rays and MRI scans, leading to quicker and more precise diagnoses. LeNet-5 is capable of performing image recognition tasks efficiently in various real-world applications.

FIG. 2 shows a flow diagram illustrating an example process for optimization of a CNN using threshold-based optimization with some aspects of the present disclosure. The methodology involves determining the optimal pruning threshold and selectively pruning weights based on their magnitude. A pre-trained network is used to evaluate the precision of the pruned model on the test set and adjust the pruning threshold accordingly. The weight matrix of the pre-trained CNN is profiled to identify the maximum weight value for each layer. This maximum weight value is used as a reference for normalizing the pruning threshold. The normalized threshold is calculated by dividing the threshold value by the maximum weight value for each layer, as shown in Equation 1.

$${Threshold}_{normalized} = \frac{Threshold}{Max ( weight {matrix}_{layer} )} \qquad ( 1 )$$

To identify the optimal threshold, the weight matrix of a pre-trained CNN is profiled, and the weight range within each layer is calculated. The weight distribution is analyzed, and the threshold is iteratively adjusted by gradually increasing it until the desired level of accuracy is achieved or a heuristically set threshold value is reached. The absolute values of the weights below the threshold are set to zero, effectively pruning them. This iterative process is performed layer by layer, in a top-down fashion, allowing fine-grained control over the pruning procedure. To evaluate the effectiveness of the approach, sparsity is measured, which refers to the percentage of pruned weights compared to the total number of weights in the network. A higher sparsity value indicates a greater reduction in network size and computational requirements. Experimental evaluations on benchmark datasets, such as MNIST, Fashion-MNIST, and SVHN, demonstrate the efficacy of range-based threshold pruning in achieving significant weight reduction with minimal loss in accuracy. Equation 2 below calculates the sparsity of a pruned neural network, representing the percentage of weights that have been pruned or set to zero compared to the total number of weights in the network. The LeNet architecture contains two convolution layers and three fully connected layers with prunable parameters.

$$Sparsity = \frac{Number of Pruned Weights}{Total Number of Weights} \times 100 \% \qquad ( 2 )$$

As described above, FIG. 2 illustrates an example pruning process 200. The pre-trained model is loaded, and initial threshold values are assigned to each layer of the model. A maximum weight value is set for each layer, and the threshold is normalized by dividing it by the maximum weight. The pruning steps are repeated for each layer as long as the accuracy of the pruned model on the test set remains above a predetermined stop accuracy threshold. As described below, a particular implementation can omit some or all illustrated features/steps, may be implemented in some embodiments in a different order, and may not require some illustrated features to implement all embodiments.

At step 202, the process 200 performs loading the pre-trained model. This involves loading the neural network that has already been trained on a dataset, so its weights are initialized with learned values.

At step 204, the process 200 performs profiling the weight matrix of the model. This step requires analyzing the weight matrix of each layer to understand the distribution of weights, helping identify which weights are significant and which can be pruned during the optimization process.

At step 206, the process 200 performs calculating the optimal threshold for pruning by normalizing the threshold value for each layer. A threshold value is set based on the weight matrix's characteristics. The threshold is normalized by dividing it by the maximum weight value of each layer, ensuring the threshold is relative to the scale of the layer's weights.

Next, the process 200 performs iterating through each layer of the model. The pruning process begins, applied layer by layer to ensure each layer is optimized individually. This step consists of two parts as described below in detail. At step 208, the process performs pruning weights below the normalized threshold by setting them to zero. This removes weights that are deemed insignificant, reducing the network's complexity and saving computational resources. At step 4b, the process performs evaluating the accuracy of the pruned model on a test set. After pruning the weights, the model is tested to see if the accuracy has been impacted. This checks how well the pruned model performs on unseen data, ensuring that pruning does not negatively affect performance.

At step 210, the process performs checking whether the accuracy falls below a predetermined stop accuracy. This ensures that pruning does not degrade the model's accuracy beyond an acceptable level. In particular, at step 210a, the process performs stopping pruning for the current layer, freeze the pruning threshold for the current layer, and proceed to the next layer if the accuracy falls below the stop threshold. If pruning causes the accuracy to decrease below the acceptable level, pruning stops for that layer, and the threshold is frozen before moving to the next layer. At step 210b, the process performs continuing to prune for the current layer if the accuracy is still above the stop threshold. If the accuracy remains acceptable, pruning continues, further reducing the layer's complexity.

At step 212, the process performs checking if the current layer is the final layer in the network. If it is, the pruning process ends for this layer, and the next layer is skipped. If it is not the final layer, pruning continues for this layer.

At step 214, the process performs increasing the threshold value and repeat the pruning process for the current layer. This step involves gradually increasing the pruning threshold to further reduce the number of weights in the layer, ensuring fine-tuned pruning that doesn't cause significant performance degradation. In some examples, the process 200 may return the pruned model and the optimal threshold values for each layer once all layers have been pruned. After pruning is completed for all layers, the optimized model and its respective pruning thresholds are returned, representing the final pruned network.

At step 216, the process performs evaluating the accuracy of the optimized model and compare it to the accuracy of the original model. In this final step, the performance of the pruned model is tested again on a test set, and the results are compared to the original, unpruned model to ensure that pruning hasn't significantly reduced performance. The accuracy metrics provide insight into the effectiveness of the pruning process.

In further embodiments, process 200 may not necessarily prune all filters of all convolutional layers of a CNN model. For example, in some recognition/classification tasks, a model may generate a relatively high classification confidence fairly early in the network (e.g., within the first or first few convolutional layers) for most inputs. For the “difficult” inputs, it may be that the model generally does not achieve higher confidence until much later in the network or not at all. In these cases, process 200 may prune the first few sequential convolutional layers since accuracy in those layers generally is more amenable to a tradeoff in favor of reduction of the model. In such cases, process 200 may even implement an “early exit” after some or all of those convolutional layers, thereby obtaining the dual benefit of reduced computation (due to pruning) for each layer as well as overall reduction in latency and computation for many inputs. Then, for more “difficult” inputs, the subsequent layers may be pruned more carefully or not at all, so as to maximize accuracy at the expense of potential additional computation.

In yet further embodiments, process 200 may profile layers' weight matrices as described above, but may only prune weights of those filters that contribute comparatively less classification confidence (or have a lower importance score/rank) than other filters in that layer. For example, in some embodiments, some or all layers may have pruning applied to all of their filters, some or all layers may have pruning applied to only some of their filters based on importance ranking, and some layers may not be pruned at all.

The proposed method dynamically sets the pruning threshold based on the weight ranges in each layer. By profiling the weight matrix and calculating the optimal threshold for each layer, this method enables fine-grained pruning, removing unnecessary weights while maintaining essential network information. The iterative adjustment of the pruning threshold, combined with a stopping condition, ensures that the pruning process balances model size reduction with accuracy preservation. This adaptive, data-driven approach to threshold-based pruning effectively utilizes the weight ranges within each layer, providing a systematic method to optimize CNN efficiency while minimizing accuracy loss. Profiling helps to understand the characteristics of the weights in each layer, aiding in determining an appropriate pruning threshold. By analyzing the weight range and distribution, a threshold can be set to effectively prune unnecessary or less important weights while preserving important network information. This profiling step is integral to making informed decisions regarding the pruning threshold, contributing to the overall effectiveness of the pruning process.

### Experimental Results

This section describes the experimental setup and validates the disclosed methodology. The experimentation evaluates the effectiveness of the threshold-based optimization technique on the LeNet-5 network using three datasets including MNIST, CIFAR10 (or Fashion-MNIST), and SVHN. The pretrained network is implemented and trained using the PyTorch framework on a cloud computing platform. The pretrained network serves as the baseline model for comparison. Multiple experiments are conducted, where the network is trained independently on each dataset. The threshold-based optimization process is applied to each baseline model, and the resulting models are assessed based on accuracy and network sparsity. Sparsity refers to the ratio of pruned weights to the total number of weights in the network. Higher sparsity values indicate a greater reduction in network size and computational demands. Below illustrates experimental results for MNIST, Fashion-MNIST, and SVHN Datasets.

The MNIST dataset is a widely used benchmark for evaluating machine learning algorithms, particularly those focused on image recognition and classification. In the current example, it consists of 60,000 training images and 10,000 testing images of handwritten digits from 0 to 9. Each image is grayscale and has a resolution of 28×28 pixels. CNNs have achieved remarkable performance on the MNIST dataset, with some models achieving error rates as low as 0.23%. The MNIST dataset serves as a valuable benchmark for assessing new machine learning algorithms, deep-learning architectures, and optimization techniques.

TABLE 1
Optimization results for LeNet with MNIST dataset

| | | | Accuracy | Average | Accuracy | |
|---|---|---|---|---|---|---|
| | | % | in regular | threshold | in pruned | Loss |
| Exp | # | weights | model | runed | model | accuracy |
| # | weights | pruned | (%) | model | (%) | (%) |
| 1 | 39,073 | 63.32 | 98.95 | 0.50 | 95.61 | 3.34 |
| 2 | 39,620 | 64.21 | 98.90 | 0.50 | 97.87 | 1.03 |
| 3 | 39,252 | 63.61 | 99.15 | 0.50 | 98.08 | 1.07 |
| 4 | 38,654 | 62.64 | 98.77 | 0.50 | 97.16 | 1.61 |
| 5 | 39,879 | 64.63 | 98.73 | 0.51 | 95.46 | 4.24 |

Table 1 above shows the results of optimizing the LeNet-5 network on the MNIST dataset for five different models trained. The network contains 61,706 trainable parameters. The optimal pruning threshold allows pruning of at least 60% of the prunable parameters, resulting in an accuracy loss of 1-5 percent.

TABLE 2
Optimization results for LeNet with MNIST dataset for one model

| | Optimal pruning | # weights in | |
|---|---|---|---|
| Layer name | threshold | baseline model | # weights pruned |
| Conv 1 | 0.67 | 150 | 100 |
| Conv 2 | 0.67 | 2,400 | 1608 |
| Fc1 | 0.67 | 48,000 | 32,160 |
| Fc2 | 0.30 | 10,080 | 5,541 |
| Fc3 | 0.30 | 840 | 564 |
| Total | Avg = 0.48 | 61,706 | 39,973 |

Table 2 above shows the optimization results for one model in detail, highlighting the number of weights pruned per layer and comparing them to the baseline model. These results underline the importance of finding the optimal pruning threshold to balance network size reduction and acceptable accuracy. In the fully connected layer 1 (FC1), 32,160 weights are pruned from 48,000, leading to approximately 67% sparsity. This pruning results in a significantly sparser network.

The FASHION-MNIST dataset is a collection of images representing clothing items, designed as a replacement for the traditional MNIST dataset. In the current example, it consists of 70,000 grayscale images categorized into 10 types of clothing, including t-shirts, dresses, and shoes. The images are 28×28 pixels and divided into a training set of 60,000 images and a test set of 10,000 images. Fashion-MNIST has been used as a testbed for evaluating new data augmentation techniques, network architectures, and training algorithms.

TABLE 3
Optimization results for LeNet with FAHSION-MNIST dataset

| | | | Accuracy | Average | Accuracy | |
|---|---|---|---|---|---|---|
| | | % | in regular | threshold | in pruned | Loss |
| Exp | # | weights | model | runed | model | accuracy |
| # | weights | pruned | (%) | model | (%) | (%) |
| 1 | 32,160 | 70.90 | 89.63 | 0.44 | 87.39 | 2.24 |
| 2 | 28,907 | 65.07 | 89.67 | 0.41 | 87.24 | 2.43 |
| 3 | 28,237 | 63.56 | 89.15 | 0.38 | 87.11 | 2.04 |
| 4 | 30,218 | 68.02 | 89.98 | 0.41 | 86.76 | 3.22 |
| 5 | 25,976 | 58.47 | 89.02 | 0.32 | 85.34 | 3.68 |

Table 3 above shows the results of optimizing the LeNet-5 network on the Fashion-MNIST dataset for five different models. The network has 62,006 trainable parameters, and the optimal pruning thresholds for each model vary. On average, 65% of the weights can be pruned with corresponding accuracy losses ranging from 2.04% to 3.68%.

TABLE 4
Optimization results for LeNet with
FASHION-MNIST dataset for one model

| | Optimal pruning | | # weights baseline |
|---|---|---|---|
| Layer name | threshold | # weights pruned | model |
| Conv 1 | 0.40 | 79 | 150 |
| Conv 2 | 0.40 | 1,272 | 2,400 |
| Fc1 | 0.40 | 16,282 | 30,720 |
| Fc2 | 0.35 | 5,147 | 10,080 |
| Fc3 | 0.15 | 150 | 840 |

| | | |
|---|---|---|
| Total | 34,160 | 44,426 |

| | |
|---|---|
| Average threshold | 0.48 |

Table 4 shows detailed optimization results for one model, including the number of pruned weights per layer compared to the baseline model. The pruning thresholds for each layer vary, and this variation demonstrates the importance of adjusting the pruning threshold for each individual layer to achieve optimal performance. The highest average optimal threshold of 0.48 results in a significant accuracy drop at the first convolution layer. As the pruning threshold increases, accuracy decreases gradually for each layer.

The Street View House Numbers (SVHN) dataset is a large-scale dataset containing images of house numbers from Google Street View. In the current example, it includes over 600,000 digit images, each cropped and resized from larger images. The digits range from 0 to 9 and vary in fonts, styles, and sizes. The SVHN dataset serves as a benchmark for evaluating machine learning models, especially in the context of digit recognition, and is often used as a more challenging alternative to the MNIST dataset due to increased variability in digit appearance, background complexity, and image quality. The dataset is available in two formats: original images with character-level bounding boxes and 32×32 images centered on a single character, similar to MNIST. The latter format is used here as LeNet-5 accepts 32×32 images.

TABLE 5
Optimization results for LeNet with SVHN dataset

| | | | Accuracy | Average | Accuracy | |
|---|---|---|---|---|---|---|
| | | % | in regular | threshold | in pruned | Loss |
| Exp | # | weights | model | runed | model | accuracy |
| # | weights | pruned | (%) | model | (%) | (%) |
| 1 | 23,106 | 52.01 | 88.37 | 0.40 | 87.00 | 1.37 |
| 2 | 33,783 | 54.48 | 88.34 | 0.40 | 85.46 | 2.88 |
| 3 | 31,351 | 50.56 | 88.69 | 0.40 | 86.72 | 1.97 |
| 4 | 33,779 | 54.48 | 88.37 | 0.35 | 87.08 | 1.29 |
| 5 | 36,166 | 58.33 | 87.54 | 0.40 | 86.34 | 1.20 |

Table 5 shows the results of optimizing the LeNet-5 network on the SVHN dataset for five models. The network has 62,006 trainable parameters, and on average, 50% of the prunable weights can be pruned, resulting in an accuracy loss of 1-3 percent.

TABLE 6
Optimization results for LeNet with SVHN dataset for one model

| | Optimal pruning | | # weights baseline |
|---|---|---|---|
| Layer name | threshold | # weights pruned | model |
| Conv 1 | 0.40 | 180 | 450 |
| Conv 2 | 0.40 | 960 | 2,400 |
| Fc1 | 0.40 | 19,200 | 48,000 |
| Fc2 | 0.35 | 7,308 | 10,080 |
| Fc3 | 0.15 | 166 | 840 |

| | | |
|---|---|---|
| Total | 36,166 | 62,006 |

| | |
|---|---|
| Average threshold | 0.34 |

Table 6 provides detailed optimization results for one model, showing the number of pruned weights per layer and a comparison to the baseline model. The average optimal pruning thresholds across all models are calculated and presented in Table 5. The results demonstrate the effectiveness of the pruning approach in optimizing the model's complexity while maintaining acceptable accuracy.

Based on the results above, the proposed range-based threshold pruning approach to LeNet enables pruning of a significant number of weights (e.g., in %) with a relatively small accuracy loss. For instance, the proposed ranged-based threshold allows between about 50% and about 65% of the weight while resulting between about 1% and about 5% accuracy loss.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A method for optimizing a pre-trained convolutional neural network (CNN) model, the method comprising:
obtaining a trained CNN model, the trained CNN model comprising a plurality of convolutional layers and associated weight matrices;
profiling a weight matrix of one or more of the plurality of convolutional layers to determine a weight distribution for the one or more layers;
determining a pruning threshold for each of the one or more convolutional layers based on the weight distribution;
iteratively pruning weights in the weight matrix of the one or more convolutional layers by setting weights below the pruning threshold to zero, to generate an initial pruned CNN model;
evaluating an accuracy of the initial pruned CNN model on a test dataset;
adjusting the pruning threshold dynamically for the one or more convolutional layers, based on the evaluated accuracy; and
generating an optimized CNN model comprising the one or more pruned convolutional layers.

2. The method of claim 1, wherein the pruning threshold for the one or more convolutional layers is determined based on a normalized weight range, wherein the normalized weight range represents a function of a maximum weight value within the one or more convolutional layers.

3. The method of claim 1, wherein the one or more of the plurality of convolutional layers are selected by sequentially selecting convolutional layers of the CNN model that exhibit a threshold confidence score for a threshold percentage of classification tasks when processing validation data, until a layer is reached that does not exhibit such a score for such a percentage.

4. The method of claim 1, wherein pruning weights iteratively comprises:
setting an initial pruning threshold for a convolutional layer;
removing weights below the threshold;
evaluating the pruned CNN model on a validation dataset;
increasing the threshold and repeating pruning if accuracy remains above a predefined threshold.

5. The method of claim 1, further comprising evaluating aggregate weight values of filters of the one or more convolutional layers and pruning an entire filter of the one or more convolution layers whenever it is determined that a sum of the filter's weights falls below a predetermined threshold.

6. The method of claim 5, wherein the pruning of the entire filter of the one or more convolutional layers comprises removing corresponding feature map channels in subsequent layers of the CNN model.

7. The method of claim 1, wherein the optimized CNN model is implemented as a specialized hardware device, the hardware device comprising an application-specific integrated circuit (ASIC), a field-programmable gate array (FPGA), or a neuromorphic processing unit having a transistor layout that performs the optimized CNN model.

8. The method of claim 1, wherein the optimized CNN model is deployed on an edge computing device, an embedded system, or an Internet of Things (IoT) device.

9. The method of claim 1, further comprising applying quantization to the optimized CNN model to reduce memory and computational requirements.

10. The method of claim 1, further comprising storing the optimized CNN model in a non-transitory computer-readable storage medium.

11. A system for CNN optimization, the system comprising:
a communication connection configured to receive a trained CNN model;
an electronic processor; and
a non-transitory computer-readable medium storing machine-executable instructions that, when executed by the electronic processor, cause the system to:
obtain a trained CNN model comprising a plurality of convolutional layers;
profile a weight matrix of a first convolutional layer to determine a weight distribution for the first convolutional layer;
determine a pruning threshold for the first convolutional layer based on the weight distribution;
iteratively prune weights from the weight matrix of the first convolutional layer by setting weights having values that are below the pruning threshold to zero;
evaluate an accuracy of the CNN model after pruning of the first convolutional layer, using a test dataset;
adjust the pruning threshold dynamically based on the evaluated accuracy; and
generate an optimized CNN model comprising the pruned first convolutional layer.

12. The system of claim 11, wherein the machine-executable instructions further cause the system to provide the optimized CNN model as an input to a circuit transistor layout application, to generate a circuit design to implement the optimized CNN model as an ASIC, FPGA, GPU, or a neuromorphic processing unit, wherein the circuit design includes inputs corresponding to input channels of the optimized CNN model and outputs corresponding to output channels of the optimized CNN model.

13. The system of claim 11, wherein the CNN model is pruned using a range-based thresholding technique, wherein the pruning threshold is determined for one or more convolutional layers based on their respective weight distributions.

14. The system of claim 11, wherein the optimized CNN model is configured for deployment on a resource-constrained device, including at least one of: an IoT edge device; an autonomous vehicle processor; a mobile device; and a medical imaging system.

15. The system of claim 11, wherein machine-executable instructions further cause the processor to:
determine an average confidence level achieved by of at least a portion of the plurality of convolutional layers of the CNN model;
if a second convolutional layer positioned sequentially after the first convolutional layer exhibits an average confidence level above a predefined threshold when performing a given classification task for a given type of dataset, profiling and pruning weights of the second convolutional layer; and
continue to sequentially profile and prune convolutional layers of the CNN model until a layer is reached that no longer exhibits an average confidence level above the predefined threshold.

16. A system for CNN optimization, the system comprising:
a communication connection configured to receive a trained CNN model;
an electronic processor; and
a non-transitory computer-readable medium storing machine-executable instructions that, when executed by the electronic processor, cause the system to:
obtain a trained CNN model comprising a plurality of convolutional layers;
assign a plurality of threshold values to first convolutional layer of the plurality of convolutional layers;
profile a weight matrix of the first convolutional layer to determine a weight distribution for the first convolutional layer;
determine a pruning threshold for the first convolutional layer based on the weight distribution and the plurality of threshold values;
iteratively prune weights from the weight matrix of the first convolutional layer by setting weights having values that are below the pruning threshold to zero;
determine an accuracy of the CNN model after pruning of the first convolutional layer, using a test dataset;
compare the accuracy to a predetermined stop accuracy;
save the pruning threshold and stop pruning weights from the weight matrix upon determining that the accuracy meets the predetermined stop accuracy; and
generate an optimized CNN model based on the pruning threshold of the first convolutional layer.

17. The system of claim 16, wherein determining a pruning threshold comprising normalizing the plurality of threshold values and dividing the normalized threshold values by a maximum weight within the weight matrix.

18. The system of claim 16, wherein the instructions further cause the system to:
iteratively prune weights from the weight matrix of the first convolutional layer upon determining that the accuracy does not meet the predetermined stop accuracy.

19. The system of claim 16, wherein the instructions further cause the system to:
evaluate aggregate weight values of filters of the one or more convolutional layers; and
prune
an entire filter of the one or more convolution layers whenever it is determined that a sum of the filter's weights falls below a predetermined threshold.

20. The system of claim 19, wherein the pruning of the entire filter of the one or more convolutional layers comprises removing corresponding feature map channels in subsequent layers of the CNN model.
